(19) United States
(12) Patent Application Publication
(10) Pub. No.: US 2013/0099443 A1
(43) Pub. Date: Apr. 25, 2013

(54) GAME APPARATUS

(71) Applicants: Masato Okuaki, Minato-ku (JP); Shinya Suga, Minato-ku (JP)

(72) Inventors: Masato Okuaki, Minato-ku (JP); Shinya Suga, Minato-ku (JP)

(73) Assignee: KONAMI DIGITAL ENTERTAINMENT CO., LTD., Minato-ku, Tokyo (JP)

(21) Appl. No.: 13/807,887

(22) PCT Filed: Jun. 29, 2011
(86) PCT No.: PCT/JP2011/064908

§ 371 Date: Dec. 31, 2012

(30) Foreign Application Priority Data
Jul. 2, 2010 (JP) 2010-152335

(51) Int. Cl. G07F 17/32

(52) U.S. Cl. CPC G07F 17/326
USPC 273/138.2

(57) ABSTRACT

A game apparatus (100) includes a medal slot mechanism (30), control device (10), and display (40). The medal slot mechanism (30) includes a rail (33) that can guide a medal (M) inserted from an insertion slot (31) to a first ejection slot (32) connecting to a field (F), a second ejection slot (52) that ejects the inserted medal (M) to a collector (H), a selector (34) that selects an exit of the medal (M), and a detector (35) that detects the medal (M) passing through a predetermined position in the rail (33) between the insertion slot (31) and the selector (34).

### TECHNICAL FIELD

The present invention relates to game apparatuses, and in particular relates to game apparatuses in which a coin pusher game is played.

### BACKGROUND ART

There is a known type of game apparatus in which a coin pusher game can be played, the coin pusher game being one in which a medal dropped on a field is pushed to move by a pusher table constantly moving with a reciprocating movement, so that medals present on the field are pushed sequentially and fall from the edge of the field. Further, there is also a known type of game apparatus in which not only the coin pusher game, but also a subgame different from the coin pusher game can be played if a predetermined condition is satisfied.

For example, in the game apparatus disclosed in Patent Document 1, a control device executes a slot game as the subgame if it is detected that a medal has passed a checker that is a predetermined route.

### CITATION

### Patent Document

Patent Document 1: Japanese Patent Publication No. 3481211

### SUMMARY OF THE INVENTION

### Technical Problem

However, in the slot game, since the control device executes an electronic lottery and merely executes control functions in accordance with the result of the lottery, there is almost nothing for the player to do. It is preferable for the player to be able to take part in the subgame by operating any item in terms of increasing the enjoyment level of the subgame.

### Solution to Problem

In order to embody the game apparatus in which the subgame involving the player's operation can be played in addition to the coin pusher game, an operating element for the coin pusher game, such as a medal slot in which the player drops medals, and an operating element for the subgame are needed. There are drawbacks in that the structure becomes complicated, and the production cost of the game apparatus is high, if both elements are provided separately.

The present invention provides a game apparatus in which a subgame involving a player's operation can be played in addition to a coin pusher game with a simple structure.

A game apparatus according to the present invention includes a medal slot mechanism including: a) an insertion slot into which a medal is inserted; b) a first ejection slot adapted for ejecting the medal inserted from the insertion slot onto a field; c) a rail that is capable of guiding the medal from the insertion slot to the first ejection slot; d) a second ejection slot adapted for ejecting the medal inserted from the insertion slot into a collector different from the field; e) a selector that is arranged in the rail and selects one of either the first ejection slot or the second ejection slot as an exit of the medal; and f) a detector that is arranged in a predetermined position in the rail between the insertion slot and the selector and detects the medal passing through the predetermined position, a control device adapted for controlling a progress of a coin pusher game in that a pusher table moves with a reciprocating movement so that the medal ejected from the first ejection slot onto the field is pushed to move by the pusher table; and a display adapted for displaying images of games, in which the second ejection slot is arranged in one of either a leading edge of the second rail extended from the selector toward the collector or a second predetermined position in the rail between the detector and the first ejection slot; the medal ejected inserted from the insertion slot is ejected onto the field without being ejected to the collector if the exit of the medal is changed to the first ejection slot by the selector, and the medal is ejected to the collector without being ejected to the field if the exit of the medal is changed to the second ejection slot by the selector, if a first condition is satisfied, the control device controls the selector so that the exit of the medal is changed to the second ejection slot, and controls the display so that an image object is displayed in accordance with a timing when the medal passes through the detector.

In the present invention, if a first condition is satisfied, the selector is controlled so that the exit of the medal is changed to the second ejection slot, and the display is controlled so that the image object is displayed in accordance with the timing when the medal passes through the detector. Therefore, a subgame that involves a player's operation can be played in addition to a coin pusher game. For example, a shooting game can be utilized as such a subgame. In the shooting game, the image is one in which an image object such as a bullet moves is displayed on the display corresponding to the timing when the medal passes through the detector each time the player inserts a medal into the medal slot mechanism. If the image object hits the image of a target object (an object for a target of the shooting) displayed in the display, a predetermined number of medals are paid off to the player as a prize. In this case, the player conducts an operation of inserting a medal into the medal slot mechanism, while timing the insertion of the medal to hit the target. In short, the medal slot mechanism serves as both an operating element for the coin pusher game and an operating element for the shooting game, so that a structure of the game apparatus is simplified in comparison with an example in which the operating element for the shooting game is arranged in addition to that for the medal slot mechanism. Therefore, according to the present invention, it is possible to provide a game apparatus in which the subgame involving a player's operation can be played in addition to the coin pusher game.

In an aspect of the game apparatus according to the present invention, it is preferable that if a second condition is satisfied, the control device controls the display so that the exit of the medal is changed to the first ejection slot, and controls the display so that the image object is displayed in accordance with a timing when the medal passes through the detector. In this aspect, the medal inserted into the medal slot mechanism is ejected from the first ejection slot onto the field, and the image object is displayed in the display in accordance with the timing when the medal passes through the detector, so that it is possible to play the coin pusher game and the subgame involving the player's operation such as the shooting game at the same time. As a result, more variations of the game are possible.

In an aspect of the game apparatus according to the present invention, the medal slot mechanism may include a rotation detecting device capable of rotating on an rotation axis and adapted for detecting a rotation angle of the rotation detecting device, and the control device may control the display so that the image object is displayed in accordance with a timing when the rotation angle detected by the rotation detecting device and a timing when the medal passes through the detector. For example, in the display, if points of intersection between the screen of the display and a virtual line that is extended along the direction of length of the rail are start positions of displaying the image object, the start position for displaying the image object varies in accordance with the rotation angle of the medal slot mechanism.

Since the distance from the leading edge of the rail to the start position for displaying the image object varies in accordance with the rotation angle of the medal slot mechanism, it is preferable that the start timing for displaying the image object in the display be later in proportion as the distance between the leading of the rail and the start position for displaying the image object is longer in order to avoid awkwardness in displaying of the image object. In the aspect of the present invention, the control device variably controls the start position and the start timing for displaying the image object in the display in accordance with the rotation of the medal slot mechanism and the timing when the medal passes through the detector in order to avoid awkwardness in displaying the image object. Therefore, for example in the shooting game, it is possible to express a situation in which the player aims the target with the image object displayed in the display by conducting an operation such as turning of the medal slot mechanism when the player inserts the medal into the medal slot mechanism, in a natural way.

In an aspect of the game apparatus according to the present invention, the control device may control the direction of the movement of the image object on the basis of the rotation angle detected by the rotation detecting device. For example, the control device may control the direction of the movement of the image object so that the direction of length of the rail coincides with the direction of the movement of the image object. Therefore, it is possible to display the image as if the medal shot from the leading edge (the first ejection slot) of the rail appears in the display as the image object. In the aspect in which the start timing for displaying the image object in the display is set in accordance with the timing when the medal passes through the detector independently of the rotation angle of the medal slot mechanism (for example in the example shown in FIG. 10), or in the aspect in which the start position for displaying the image object in the display is fixed in a predetermined position independently of the rotation angle of the medal slot mechanism, the control device may control the direction of the movement of the image object on the basis of the rotation angle detected by the rotation detecting device.

The control device may control the moving velocity of the image object in accordance with the time when the medal passed through. More specifically, since the time when the medal passes through the detector becomes shorter in proportion as the moving velocity of the medal in the rail becomes larger, the control device may control the moving velocity so that the moving velocity of the image object becomes larger in proportion as the time when the medal passes through the detector becomes shorter. Therefore, since it is possible to reflect the moving velocity of the medal to the display of the image object, the image object is displayed in a more natural way.

In an aspect of the game apparatus according to the present invention, the edge of the field in which the medal may drop is divided into effective edges and ineffective edges. Furthermore, if the medal is dropped from one of the effective edges, a value corresponding to the dropped medal may be given to a player as a prize, and if the medal is dropped from one of the ineffective edges, the medal may be collected by the collector without anything being given to the player as a prize. In this aspect, since the collector is common to the medal collected after falling from the ineffective edge in a normal coin pusher game and the medal collected after being inserted into the medal slot mechanism (the medal ejected from the second ejection slot) if the first condition is satisfied (in the case in which the subgame involving the player's operation is played), the structure is simplified in comparison with an example in which separate collectors are provided respectively.

In an aspect of the game apparatus according to the present invention, a shield is provided in order to hide the medal ejected from the second ejection slot to the collector from the player. Therefore, it is possible to prevent the player from having a negative impression that the inserted medal is collected in the game apparatus. Since the scene in which the inserted medal is collected by the collector is hidden from the player, it is possible to further enhance an effect that the image can be displayed as if the inserted medal appears in the display as the image object.

In an aspect of the game apparatus according to the present invention, the medal slot mechanism includes multiple light emitting devices that may be arranged along the rail from the detector to the first ejection slot, and the control device may control the emission of each of the light emitting devices on the basis of the timing when the medal passes through the detector. For example, the control device may control the emission of each light emitting device so that each light emitting device emits light sequentially during the period from the timing when the control device detects that the medal passes through the detector to the timing when the display of the image object should be started in the display, even if the exit of the medal is changed to the second ejection slot (if the medal is not ejected from the first ejection slot). Therefore, notwithstanding that the medal is not actually ejected from the first ejection slot, it is possible to display the image as if the medal passes through the rail from the detector to the first ejection slot.

### BRIEF DESCRIPTION OF THE DRAWINGS

FIG. 1 is a block diagram showing a schematic structure of a game apparatus according to an embodiment of the present invention;

FIG. 2 is a plan view showing a schematic structure of a part of a station;

FIG. 3A is an explanatory view showing a movement of a medal toward a floodlight;

FIG. 3B is a chart for explaining a timing at which a detection signal is output;

FIG. 4 is a perspective view showing a specific structure of a medal slot mechanism;

FIG. 5 is a schematic view for explaining the situation in which a shooting game as a special game is executed;

FIG. 6 is a schematic view for explaining the situation in which a shooting game as a special game is executed;

FIG. 7 is a schematic view for explaining an example in which two detectors are provided;

FIG. 8 is a timing diagram for explaining an example in which an inserted medal passes through two detectors;

FIG. 9 is a schematic view for explaining a variation according to the present invention; and

FIG. 10 is a schematic view for explaining a variation according to the present invention.

### DESCRIPTION OF EMBODIMENTS

### A: Embodiment

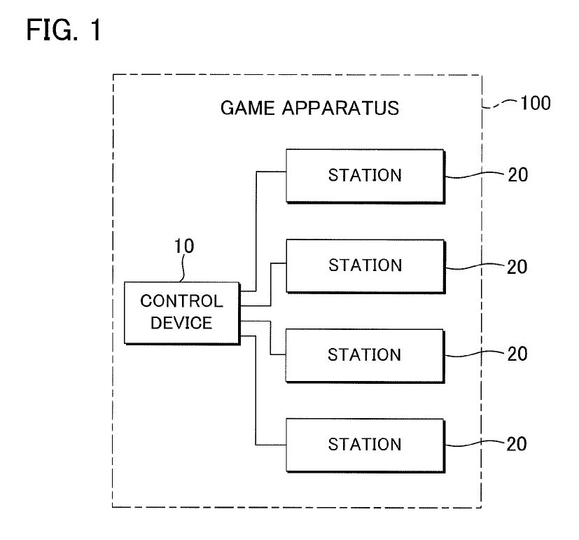

FIG. 1 is a block diagram showing a structure of a game apparatus 100 according to an embodiment of the present invention. The game apparatus 100 is located at an amusement center in a shopping area and the like, and is utilized by users. In the game apparatus 100, a coin pusher game is played. As shown in FIG. 1, the game apparatus 100 according to the embodiment includes a control device 10 and four stations 20. The control device 10 is a computer and performs as a control center for controlling the entire game apparatus. For example, the control device 10 controls progress of a game played at each station 20. At each station 20, one player can play the game. In the embodiment, the number of the stations 20 is four; however, it may be set to any number. Multiple players may play the game at the one station 20. A control device for controlling progress of the game played at each station 20 may be provided for each station 20, and a central control device for controlling each control device may be provided separately from the station 20.

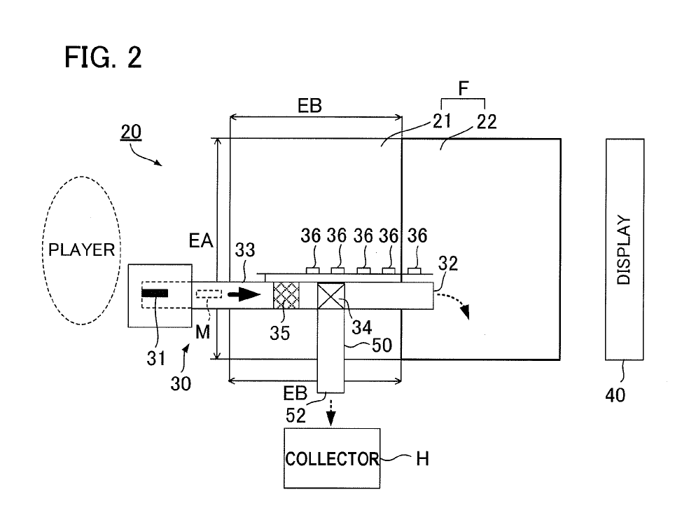

FIG. 2 is a schematic plan view showing a schematic structure of a part of one station 20. As shown in FIG. 2, the station 20 includes a main table 21, a coin pusher table 22, a medal slot mechanism 30, and a display 40. The main table 21 is a plate-shaped component fixed almost horizontally. The coin pusher table 22 is a plate-shaped component that is arranged on the main table 21, and moves along the surface of the main table 21. More specifically, the coin pusher table 22 moves back and forth (i.e., from the left side to the right side and vice versa in FIG. 2) as the player who plays the game at the station 20 faces the coin pusher table 22. The surface of the main table 21 and the surface of the coin pusher table 22 are collectively called “Field F” in the embodiment. Although details are not shown in FIG. 2, multiple medals M are randomly placed on the field F. The “medal” is a disk-shaped object necessary to take part in the game, and may also be called a “coin”. The medal or coin includes a coin as a currency in the real world and also a token coin.

The display 40 shown in FIG. 2 displays an image and the like corresponding to progress of the game executed at the station 20 under the control of the control device 10. The image is called a “game image” in the embodiment. In the embodiment, the display 40 is composed of a liquid crystal display apparatus. A display screen of the display 40 is arranged so as to face the player who plays the game at the station 20 across the field F.

As shown in FIG. 2, the medal slot mechanism 30 includes an insertion slot 31 into which the medal M is inserted, a first ejection slot 32 that ejects the medal M inserted from the insertion slot 31 onto the field F, a rail 33 that can guide the medal M from the insertion slot 31 to the first ejection 32, a selector 34 that is arranged on the rail 33 and selects an exit of the medal, a detector 35 that is arranged on a predetermined position of the rail 33 between the insertion slot 31 and the selector 34, multiple light emitting devices 34 that are arranged along the portion of the rail 33 between the detector 35 and the first ejection slot 32, and a second rail 50 that is extended from the middle of the rail 33.

As shown in FIG. 2, the second rail 50 is extended from the selector 34 toward a collector H, which is different from the field F. A second ejection slot 52, which is formed on the leading edge of the second rail 50, has a function to eject the medal M inserted from the insertion slot 31 onto the collector H. In the embodiment, the second rail 50 functions as a shield to hide the medal M ejected from the second ejection slot 52 onto the collector H from the player. Thus, there is an advantage in being able to prevent the player from having a negative impression when the medal inserted into the insertion slot 31 by the player is collected in the game apparatus 100.

The selector 34 shown in FIG. 2 selects one of either the first ejection slot 32 or the second ejection slot 52 as the outlet of the medal under the control of the control device 10. In the embodiment, an actuator, which is separate from the selector 34 and is not shown in the drawings, is arranged in the medal slot mechanism. The actuator actuates the selector 34 in accordance with control signals from the control device 10. For example, if the control signal from the control device 10 indicates that the first ejection slot 32 is designated as the exit of the medal, the actuator actuates the selector 34 so that the first ejection slot 32 functions as the exit of the medal. However, if the control signal from the control device 10 indicates that the second ejection slot 52 is designated as the exit of the medal, the actuator actuates the selector 34 so that the second ejection slot 52 functions as the exit of the medal. If the first ejection slot 32 is selected as the exit of the medal by the selector 34, the medal M inserted from the insertion slot 31 is ejected from the first ejection slot 32 without being ejected into the collector H. However, if the second ejection slot 52 is selected as the exit of the medal by the selector 34, the medal M inserted from the insertion slot 31 is ejected from the second ejection slot 52 into the collector H by way of the selector 34 and the second rail 50.

Although details are not shown in FIG. 2, a component that can select one of either a first state or a second state is utilized as the selector 34, the first state being one in which the path leading to the first ejection slot 32 (i.e., the portion from the selector 34 to the first ejection slot 32 in the rail 33) is shut off, and the path leading to the second ejection slot 52 (the second rail 50) is opened, in the rail 33, the second state being in which the path leading to the second ejection slot 52 is shut off, and the path leading to the first ejection slot 32 is opened, in the rail 33. The selector 34 selects one of either the first state or the second state as the status of the rail 33 in accordance with whether a solenoid is excited or not excited. Since this is one example, any type of selector may be utilized as long as it selects one of the first ejection slot 32 and the second ejection slot as the exit of the medal M.

The detector 35 shown in FIG. 2 detects the medal M that passes through a predetermined position between the insertion slot 31 and the selector 34 in the rail 33. In the embodiment, the detector 35 is comprised of a photo interrupter. Specifically, the detector 35 includes a light emitting element and a light receiving element, which are not shown in the drawings, that face each other across the path of the medal M, and a signal output device, which is also not shown in the drawings, and outputs a detection signal d. It is detected whether or not the emitted light from the light emitting element is blocked off, so that it is possible to determine whether or not the medal is present. If the emitted light from the light emitting element is received by the light receiving element (i.e., the emitted light from the light emitting element is not blocked off by an object), the signal output device outputs the detection signal d at a low-level to the control device 10. If the emitted light from the light emitting element is not received by the light receiving element (i.e., the emitted light from the light emitting element is blocked off by an object), the signal output device outputs the detection signal d with a high-level to the control device 10. However, since the present invention is not limited to this example, the signal output device may output the detection signal d with a high-level to the control device 10 if the emitted light is received by the light receiving element. Furthermore, the signal output device may output the detection signal d with a low-level to the control device 10 if the emitted light is not received by the light receiving element.

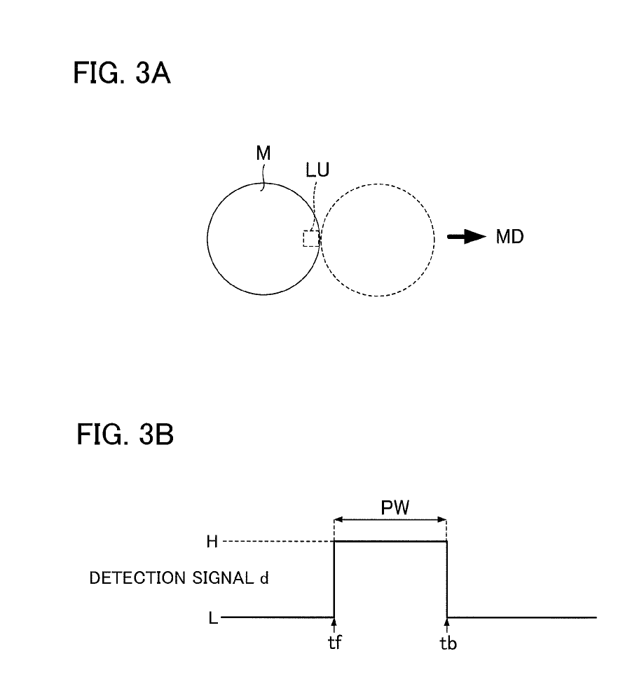

It is assumed that the emitted light from the light emitting element LU is blocked off by the edge of the anterior side (i.e., leading edge) of the medal M if the medal M that passes through the rail 33 from the insertion slot 31 toward the selector 34 moves to the direction MD as shown in FIG. 3A. Suppose the timing at which the emitted light from the light emitting element LU is blocked off by the leading edge of the medal M is tf. The detection signal d changes from a low-level to a high-level at the timing tf, as shown in FIG. 3B. It is assumed that the medal M moves on the rail 33 after that, so that the emitted light from the light emitting element LU is not block off by the edge of the posterior side (i.e., trailing edge) of the medal M as shown by a dotted line in FIG. 3A. Suppose the timing at which the emitted light from the light emitting element LU is not blocked off by the trailing edge of the medal M is tb. The detection signal d changes from a high-level to a low-level at the timing tb as shown in FIG. 3B. The length of time (i.e., pulse width PW) changes in accordance with the moving velocity of the medal M, so that the pulse width PW becomes narrower in proportion as the moving velocity of the medal M is greater. The control using the pulse width PW will be described later.

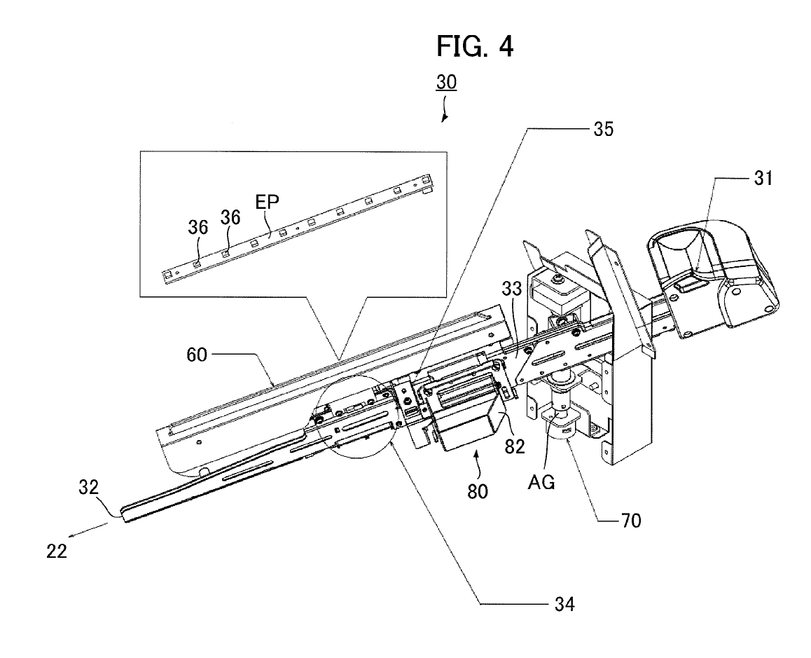

FIG. 4 is a perspective view showing a specific structure of the medal slot mechanism 30. The second rail 50 and the second ejection slot 52 are not shown in FIG. 4. The other components having the same reference symbols as those in FIG. 2 are shown in FIG. 4. Explanations that are the same as those for FIG. 2 are omitted. As shown in FIG. 4, a light emitting device 60 that includes a light emitting substrate EP is arranged over the rail 33. Multiple light emitting devices 36 are arranged at a predetermined interval on the light emitting substrate EP. The light emitting device 36 includes a light emitting diode. The position relationship between the light emitting substrate EP and the rail 33 is determined so that the multiple light emitting devices 36 are arranged along the rail 33 from the detector 35 to the first ejection slot 32. Since it is sufficient that the light emitting devices 36 be arranged over the portion of the rail 33 between the detector 35 and the first ejection 32 at least, these are not always arranged over the detector 35 or the first ejection slot 32 in the rail 33.

As shown in FIG. 4, the medal slot mechanism 30 can rotate on a rotation axis AG, and includes a rotation angle detector 70 that detects the rotation angle of the medal slot mechanism 30. The rotation angle detector 70 outputs a voltage signal corresponding to the rotation angle of the medal slot mechanism 30 to the control device 10. Thus, the control device 10 can detect the rotation angle of the medal slot mechanism 30.

As shown in FIG. 4, the medal slot mechanism 30 includes an unusual medal ejecting mechanism 80 for ejecting an unusual medal having a different shape from that of a normal medal. The unusual medal rejecting mechanism 80 is arranged in the rail 33 between the insertion slot 31 and the detector 35, and an unusual medal storage 82 that stores unusual medals. Although explanation of details is omitted, the medal ejecting mechanism 80 ejects a medal having a smaller diameter than that of a normal medal in the embodiment. Such an unusual medal cannot pass through the rail 33 in which the medal ejecting mechanism 80 is arranged, but it is collected in the unusual medal storage 82.

Referring to FIG. 2, the game played in the station 20 will be described below. In the embodiment, three kinds of games, which are a coin pusher game, a slot game, and a special game, are played. The slot game and the special game are ones that start if conditions corresponding to respective games are satisfied. These games are different form the coin pusher game, and are called a “subgame”. The special game is one in which the player can take part by operating any item. Details follow.

The situation in which the coin pusher game is executed will be described below. In a state of the beginning at which the player starts the game, the control device 10 controls the game apparatus 100 so as to play the coin pusher game. In this game, the first ejection slot 32 is determined as the exit of the medal M. Thus, the medal M inserted from the insertion slot 31 by the player is ejected onto the field F without ejecting into the collector H. When the medal M ejected from the medal slot mechanism 30 onto the field F is pushed to move by the pusher table 22 moving with a reciprocating movement, so that medals M present on the field F are pushed sequentially by the ejected medal M and fall from the edge (i.e., peripheral edge) of the main table 21.

The edges from which the medal M can fall among the edges of the main table 21 are divided into an effective edge EA and ineffective edges EB. The effective edge EA is one on the near side (i.e., left side in FIG. 2) as the player faces the coin pusher table 22, between the edges of the main table 21 in the direction of the reciprocating movement of the coin pusher table 22. The ineffective edges EB are ones from which the medal M can fall between the edges of the main table in a perpendicular direction to the direction of the reciprocating movement of the coin pusher table 22. In other words, the ineffective edges EB are ones from which the medal M can fall and ones that are other than the effective edge EA among the edges of the main table 21. The medal M fallen from the effective edge EA is paid off to the player. However, the medal M fallen from the ineffective edge EB is not paid off to the player, but is collected in collector H. This is the coin pusher game. In the embodiment, the collector H is configured to be able to pay off the stored medal M onto the field F.

The situation in which the slot game is executed will be described below. Although details are not shown, the station 20 includes at least one checker detector (not shown) that detects the medal M passing through the checker (not shown) as a predetermined route on the field F. If the medal M passing through the checker is detected by the checker detector, the control device 10 executes the slot game as the subgame. In the slot game, the control device 10 executes an electronic lottery and performs a control in accordance with the result of the lottery (i.e., big bonus prize, special prize, loss). For example, if the result of the electronic lottery is the big bonus prize, the control device 10 controls the display 40 so that the display 40 displays images showing a dramatic presentation for drawing of the lottery and the result of the lottery, and controls the collector H so that a predetermined number of medals M, e.g. a thousand medals M, are paid off onto the field F.

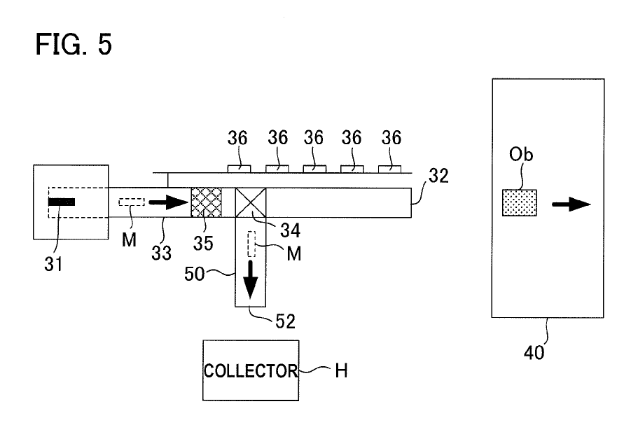

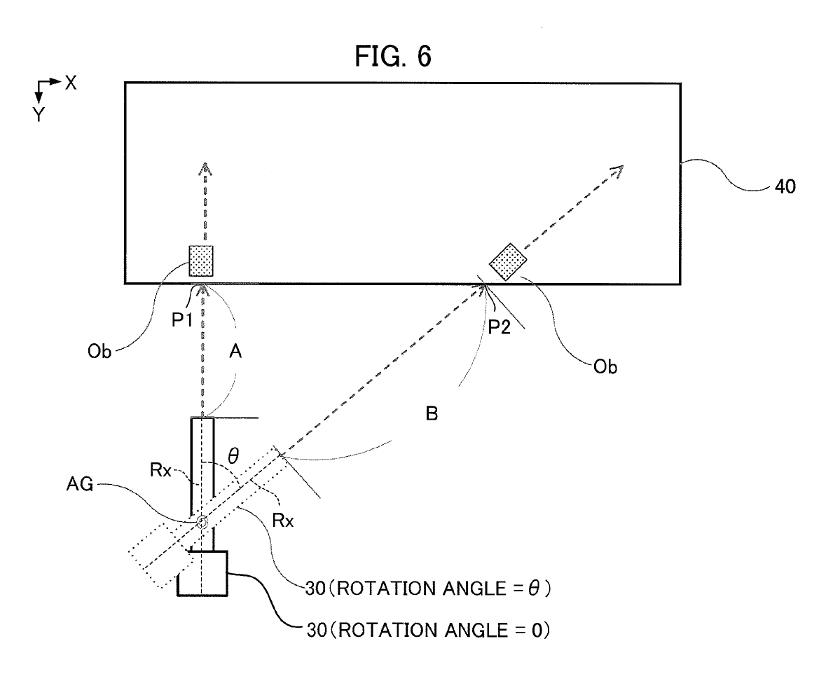

Referring to FIG. 5 and FIG. 6, the situation in which the special game is executed will be described. FIG. 5 and FIG. 6 are schematic views showing the situation in which the special game is executed. In the embodiment, a shooting game is presented as the special game. Since this is an example, it is possible to present various types of games as the special game. In this shooting game, pictures in which an image object Ob, such as a bullet, moves are displayed on the display 40 each time the player insert the medal M into the medal slot mechanism 30. If the image object Ob hits a target (not shown), which is an object as a mark for shooting and is displayed on the display 40, a predetermined number of medals M are paid off as a special service. Specific embodiments of this shooting game will be described below.

The control device 10 executes the shooting game if a first condition is satisfied. More specifically, the control device 10 executes the shooting game if the special prize is drawn in the electronic lottery in the slot game. As shown in FIG. 5, the control device 10 controls the selector 34 so that the exit of the medal M is changed to the second ejection slot 52. Thus, the medal M inserted from the insertion slot 31 is ejected to the collector H without being ejected onto the field F. In the embodiment, since the collector H is common to the medal collected after falling from the ineffective edge EB in the coin pusher game and the medal collected after being inserted into the medal slot mechanism 30 in the shooting game (special game), the structure is simplified in comparison with an embodiment in which separate collectors are provided respectively.

When executing the shooting game, the control device 10 controls the display 40 so as to display the image object Ob in accordance with the timing at which the medal M passes through the detector 35. More specifically, the control device 10 detects the passing of the medal M at the detector 35 on the basis of the detection signal d from the detector 35. In other words, the control device 10 detects that the detection signal d has changed from a low-level to a high-level, so that the control device 10 detects that the medal M begins to pass through the detector 35. The control device 10 controls the display 40 so that the displaying of the image object Ob is started at the timing (time) after a predetermined time from the detected timing. Thus, notwithstanding that the exit of the medal M is the second ejection slot 52 (i.e., the medal M is not ejected from the leading edge (the first ejection slot 32) of the rail 33), it is possible to display the image as if the medal passes through the rail 33 after the selector 34, and appears in the display 40.

The control device 10 controls the display 40 so that it displays the image object Ob in accordance with not only the timing at which the medal M passes through the detector 35, but also the rotation angle of the medal slot mechanism 30. Specific embodiment will be described below. As described above, the rotation angle of the medal slot mechanism 30 is detected by the rotation detecting device 70 shown in FIG. 4. In the embodiment, the medal slot mechanism 30 can rotate (turn) in an approximately horizontal direction. As shown in FIG. 6, it is assumed that the rotation angle of the medal slot mechanism 30 is “0” when the leading edge of the rail 33 faces directly forward (i.e., the direction of length of the rail 33 is the vertical direction to the surface of the display 40). This orientation is set as a reference orientation, so that the rotation angle of the medal slot mechanism 30 is detected on the basis of the reference orientation.

As shown in FIG. 6, in the embodiment, the points P1, P2 of intersection between the screen of the display 40 and a virtual line Rx that is extended along the direction of length of the rail 33 are start positions for displaying the image object Ob. Thus, the start position for displaying the image object Ob differs between when the rotation angle of the medal slot mechanism 30 is “θ” and when the rotation angle is “0”. As is understood from FIG. 6, the distance between the leading edge of the rail 33 and the start position for displaying the image object Ob differs corresponding to the rotation angle of the medal slot mechanism 30. More specifically, the distance B in which the rotation angle is “θ” (i.e., the distance between the leading edge of the rail 33 and the start position P2 of displaying the image object Ob) is longer than the distance A in that the rotation angle is “0” (i.e., the distance between the leading edge of the rail 33 and the start position P1 of displaying the image object Ob). Thus, in order to avoid awkwardness in displaying the image object Ob, it is preferable that the start timing for displaying the image object Ob when the rotation angle of the medal slot mechanism 30 is “0” be more posterior (later) than that when the rotation angle of the medal slot mechanism 30 is “0”.

Accordingly, in the embodiment, the control device 10 variably controls the start position and the start timing for displaying the image object Ob in the display 40 corresponding to the rotation angle of the medal slot mechanism 30 in order to avoid awkwardness in displaying the image object Ob. More specifically, the control device 10 controls the start position so that the start position P1 is the start position for displaying the image object Ob when the rotation angle is “0”, and the start position P2 is the start position for displaying the image object Ob when the rotation angle is “θ”. Furthermore, the control device 10 controls the start timing so that the start timing for displaying the image object Ob when the rotation angle is “θ” is later than when the rotation angle is “0”. In the embodiment, the control device 10 controls the start timing so that the start timing for displaying the image object Ob is later in proportion as the rotation angle of the medal slot mechanism 30 is greater. Thus, since the rotation angle of the medal slot mechanism 30 is taken into account when displaying the image object Ob, it is possible to display the image object Ob in a natural way.

In the embodiment, the control device 10 controls the direction of the movement of the image object Ob on the basis of the rotation angle of the medal slot mechanism 30. More specifically, as shown in FIG. 6, since the control device 10 controls the direction of the movement of the image object Ob so that the direction of length of the rail 33 coincides with the direction of the movement of the image objection Ob, it is possible to display the image as if the medal M passes through the rail 33 after the selector 34, and appears in the display 40, notwithstanding that the exit of the medal M is the second ejection slot 52.

If the screen of the display 40 inclines to a horizontal plane, the control device 10 controls the direction of the movement of the image object Ob on the screen of the display 40 so that the image object Ob is displayed as if it moves along the direction of the movement of the medal M. This embodiment is involved in the concept in which the direction of the movement of the image object Ob is controlled so that the direction of length of the rail 33 coincides with the direction of the movement of the image object Ob.

The control device 10 controls the moving velocity of the image object Ob in accordance with the time when the medal M passes through the detector 35. Since the time when the medal M passes through the detector 35 becomes shorter in proportion as the moving velocity of the medal M becomes greater, the control device 10 controls the moving velocity so that the moving velocity of the medal M becomes greater in proportion as the time when the medal passes through the detector 35 is shorter. More specifically, the control device 10 controls the moving velocity so that the moving velocity of the image object Ob becomes greater in proportion as the difference between the time (timing) when the detection signal d changes from a low-level to a high-level and the time (timing) when the detection signal d changes from a high-level to a low-level is less, i.e., the pulse width (time length) PW shown in FIG. 2 is narrower. In other words, if the pulse width is not less than 60 ms, the control device 10 sets the moving velocity of the image object Ob to a low-level velocity. If the pulse width is not less than 40 ms but is less than 60 ms, the control device 10 sets the moving velocity of the image object Ob to a middle-level velocity. If the pulse width is less than 40 ms, the control device 10 sets the moving velocity of the image object Ob to a high-level velocity. Thus, since the moving velocity of the image object Ob can be reflected to the display of the image object Ob, it is possible to display the image object Ob in a natural way.

The moving velocity of the medal M may be calculated on the basis of the moving distance of the medal M and the difference between the time (timing) when the detection signal d changes from a low-level to a high-level and the time (timing) when the detection signal d changes from a high-level to a low-level. Then, the calculated moving velocity may be utilized as the moving velocity of the image object Ob. Furthermore, the moving velocity of the image object Ob may be selected in stages corresponding to the calculated moving velocity.

The control device 10 controls the emission of light in each light emitting device 36 on the basis of the timing when the medal M passes through the detector 35. More specifically, if the control device 10 detects that the medal M begins to pass through the detector 35, the control device 10 controls the emission of light in each light emitting device 36 so that each light emitting device 36 emits light in a sequence during the period from the timing when the control device 10 detects that the medal M begins to pass through the detector 35 (i.e., the time when the pulse waveform rises as shown in FIG. 2) to the timing when the image object Ob should be displayed on the screen of the display 40. The emission of light is controlled so that the light emitting device 36 emits light at a later timing in proportion as the light emitting device 36 is arranged in a position closer to the first ejection slot 32.

In the embodiment, the time length until the lowest light emitting device 36 arranged in a position closest to the first ejection slot 32 finishes emitting light after the uppermost light emitting device 36 arranged in a position closest to the detector 35 emits light and the following light emitting device 36 emits light sequentially is set to the same time length as that until the medal M passing through the rail 33 at a predetermined velocity reaches the first ejection slot 32 after it has passed through the detector 35, or that until the medal M reaches a position closer to the lowest light emitting device 36 after it has passed through a position closer to the uppermost light emitting device 36 on the rail 33. Thus, notwithstanding that the medal M has not actually passed through the rail 33 after the selector 34, it is possible to display the image as if the medal M passes through the rail 33 after the selector 34. Since the control device 10 controls the emission of light of each light emitting device 36 on the basis of the timing when the medal M passes through the detector 35 even when the coin pusher game is played, i.e., the medal M passes through the rail 33 after the selector 35, it is possible to further enhance the abovementioned effect.

As described above, the second rail 50 has a function as a shield to hide the medal M ejected from the second ejection slot 52 onto the collector H from the player. Since the scene in which the inserted medal M is collected by the collector H is hidden from the player, it is possible to further enhance an effect that it is possible to display an image as if the inserted medal M appears in the display 40 as the image object Ob.

As explained above, according to the embodiment, it is possible to embody the game apparatus in which the subgame (e.g. shooting game) involving the player's operation can be played in addition to the coin pusher game. In the shooting game, the player has an operation such as turning the medal slot mechanism 30 in order to aim at a target when the player inserts the medal M into the medal slot 30. Thus, since the medal slot mechanism 30 serves as both the operating element for the coin pusher game and that for the shooting game, it is possible to simplify the structure in comparison with an embodiment in which the operating element for the shooting game is arranged separately from that for the medal slot mechanism 30. Thus, according to this embodiment, there is an advantage to be able to provide a game apparatus in which the subgame involving the player's operation can be played in addition to the coin pusher game with a simple structure.

### B: Variations

The above-described embodiments may be modified variously. Specific variations will be exemplified next. At least two examples optionally selected from among the examples below may be combined.

### B.1. Variation 1

In the above-described embodiment, the control device 10 controls the display of the image object Ob on the basis of the time when the detection signal d from the detector 35 changes from a low-level to a high-level (i.e., the time when the pulse waveform shown in FIG. 2 rises). However, the present invention is not limited to this embodiment. For example, the control device 10 may control the display 40 so that the display of the image object Ob begins at the timing after a predetermined time length from the timing when detecting that the medal M finishes passing through the detector 35 by detecting that the detection signal d changes from a high-level to a low-level. In short, the timing when the medal M begins to pass through the detector 35 may be utilized in place of the timing when the medal M passes through the detector 35. Furthermore, the timing when the medal M finishes passing through the detector 35 may be utilized in place of the timing when the medal M passes through the detector 35.

### B.2. Variation 2

In the above-described embodiment, the medal M inserted into the medal slot mechanism 30 is not provided onto the field F when the shooting game is played. The present invention is not limited to this embodiment. The medal inserted into the medal slot mechanism 30 may be provided onto the field F while playing the shooting game. For example, the control device 10 may control the game apparatus so that the control device 10 sets the first ejection slot 32 as the exit of the medal M, and executes both the shooting game and the coin pusher game, if the second condition different from the first condition is satisfied. Thus, there is an advantage in that variations of the game are increased. The category of the second condition can be set freely, so that a variety of condition can be set. Though this can be applied to the first condition in the same way, it is necessary that the first condition be different from the second condition.

The shooting game may be played even if the medal M inserted into the insertion slot 31 is ejected from the first ejection slot 32 to the field when a third condition is satisfied in the game apparatus not including the selector 34, the second rail 50, and the second ejection slot 52. The third condition can be freely set in the same way that the first condition and the second condition can be freely set.

### B.3. Variation 3

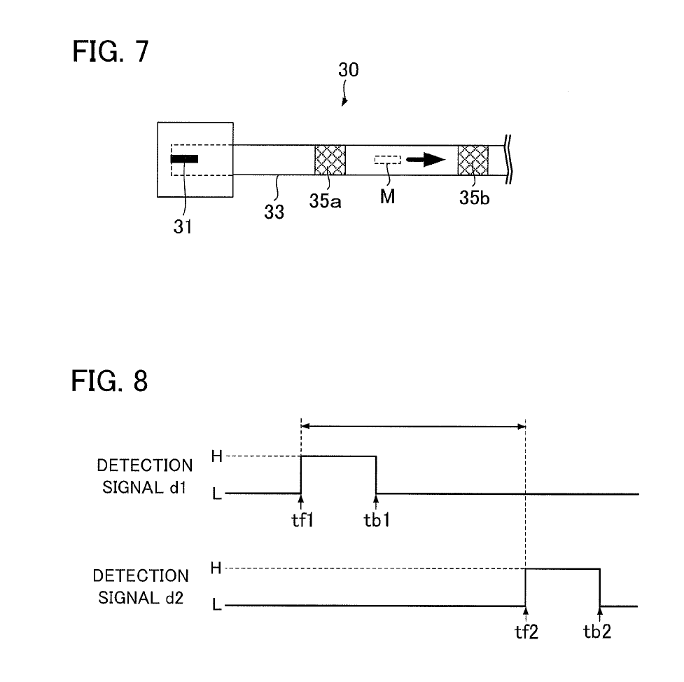

In the above-described embodiment, one detector 35 is arranged in the rail 33 between the insertion slot 31 and selector 34. However, the present invention is not limited to this embodiment. Multiple insertion slots 35 may be arranged in the rail 33 between the insertion slot 31 and selector 34. For example, as shown in FIG. 7, two detectors 35 (35a, 35b) may be arranged in the rail 33 between the insertion slot 31 and the selector 34 (not shown in FIG. 7). A first position at which the detector 35a is arranged is located at an interval of a predetermined distance from a second position at which the detector 35b is arranged. The detector 35a (the first position) is closer to the insertion slot 31 than to the detector 35b. The detector 35b is closer to the selector 34 than to the detector 35a.

In the variation shown in FIG. 7, the control device 10 controls the moving velocity of the image object Ob in accordance with the difference between the timing when the medal M passes through the detector 35a and the timing when the medal M passes through the detector 35b, i.e., the time when the medal M passes through two detectors 35a and 35b. Since the time when the medal M passes through two detectors 35a and 35b becomes shorter in proportion as the moving velocity of the medal M is greater, the control device 10 controls the moving velocity so that the moving velocity of the image object Ob becomes greater in proportion as the time when the medal M passes through two detectors 35a and 35b is shorter. More specific details will be given below.

A situation in which the medal M inserted from the insertion slot 31 passes through the detector 35a and 35b will be described. As shown in FIG. 8, the detection signal d1 output from the detector 35a changes from a low-level to a high-level at the timing tf1 when the medal M begins to pass through the first position (detector 35a). The detection signal d1 output from the detector 35a changes from a high-level to a low-level at the timing tb1 when the medal M finishes passing through the first position. The detection signal d2 output from the detector 35b changes from a low-level to a high-level at the timing tf2 when the medal M moving toward the selector 34 in the rail 33 begins to pass through the second position (detector 35b). The detection signal d2 output from the detector 35b changes from a high-level to a low-level at the timing tb2 when the medal M finishes passing through the second position.

The control device 10 controls the moving velocity of the image object Ob so that the moving velocity becomes larger in proportion as the difference between the timing tf1 when the detection signal d1 from the detector 35a changes from a low-level to a high-level and the timing tf2 when the detection signal d2 from the detector 35b changes from a low-level to a high-level is smaller, regarding the difference between the timing tf1 and the timing tf2 as the time when the medal M passes through two detectors 35a and 35b. Thus, the moving velocity of the medal M can be reflected by the display of the image object Ob. In the variation, the difference between the timing tf1 and the timing tf2 is regarded as the time when the medal M passes through two detectors 35a and 35b. However, the present invention is not limited to this variation. The moving velocity of the image object Ob may be controlled so that the moving velocity becomes greater in proportion as the difference between the timing tb1 when the detection d1 from the detector 35a changes from a high-level to a low-level and the timing tb2 when the detection signal d2 from the detector 35b changes from a high-level to a low-level is less, regarding the difference between the timing tb1 and the timing tb2 as the time when the medal M passes through two detectors 35a and 35b. The moving velocity of the image object Ob can be controlled so that the moving velocity becomes greater in proportion as the difference between the timing tf1 and the timing tb2 is less, regarding the difference between the timing tf1 and the timing tb2 as the time when the medal M passes through two detectors 35a and 35b. The moving velocity of the image object Ob can be controlled so that the moving velocity becomes greater in proportion as the difference between the timing tb1 and the timing tf2 is less, regarding the difference between the timing tb1 and the timing tf2 as the time when the medal M passes through two detectors 35a and 35b.

In the above-described variations, the control device 10 may determine whether the direction of the movement of the medal M is normal or not on the basis of the timing (tf1 or tb1) when the detection signal d1 from the detector 35a changes and timing (tf2 or tb2) when the detection signal d2 from the detector 35b changes. More specific details will be described below. In one play in the shooting game, the time when the medal M passes through the detector 35a is the prior time to that when the medal M passes through the detector 35b as long as the medal M moves inserted from the insertion slot 31 toward the selector 34 (i.e., the direction of the movement of the medal M is normal). Since the timing (tf1 or tb1) when the detection signal d1 from the detector 35a changes is prior to the timing (tf2 or tb2) when the detection signal d2 from the detector 35b changes, the control device 10 determines that the direction of the movement of the medal M is normal if the timing (tf1 or tb1) is prior to the timing (tf2 or tb2) when the detection d2 from the detector 35b changes.

However, the control device 10 determines that the direction of the movement of the medal M is not normal, and controls the game apparatus so that the game is stopped if the timing (tf1 or tb1) when the detection d1 from the detector 35a changes is posterior to the timing (tf2 or tb2) when the detection signal d2 from the detector 35b changes. Thus, it is possible to prevent an illegal act from occurring, the illegal act being one in which after a medal that is tied with a thread is inserted from the insertion slot 31 to play the shooting game, the thread is pulled so that the medal M returns to the insertion slot 31, and the next shooting game is played by using the returned medal M. It is possible to prevent a similar illegal act from occurring even when not only the shooting game but also the coin pusher game is played.

In the above-described embodiment, multiple light emitting devices 36 are arranged along the rail 33 from the detector 35b to the first ejection slot 32, so that the uppermost light emitting device 36 arranged at a closest position to the detector 35b emits light, and the following light emitting devices 36 emit light sequentially. Then, the lowest light emitting device 36 arranged at the closest position to the first ejection slot 32 emits light. The length of time from the time when the uppermost light emitting device 36 emits light until the lowest light emitting device 36 finish emitting light is variable corresponding to the time when the medal M passes through two detectors 35a and 35b. More specifically, since the moving velocity of the medal M is regarded as becoming greater in proportion as the time when the medal M passes through two detectors 35a and 35b is shorter, the time length from the time when the uppermost light emitting device 36 emits light, and the following light emitting devices 36 emit light sequentially, until the lowest light emitting device 36 finishes emitting light becomes shorter in proportion as the time when the medal M passes through two detectors 35a and 35b is shorter. Thus, since the moving velocity of the medal M is reflected to the control of emitting light in each light emitting device 36 (the control to switch emission of light and non-emission of light), it is possible to further enhance an effect in that the medal M can be displayed as if it passes through the rail 33 from the detector 35 to the first ejection slot 32.

### B.4. Variation 4

In the above-described embodiment, the second ejection slot 52 is arranged in the leading edge of the second rail 50 that is extended from the selector 34 toward the collector H. The present invention is not limited to this embodiment. For example, the second ejection slot 52 may be arranged in the rail 33 without being arranged in the second rail 50. More specifically, the second ejection slot 52 may be arranged at a predetermined second position in the rail 33 (e.g., the bottom face of the portion in which the selector 34 in the rail 33 is arranged). In this variation, the medal M is dropped from the second ejection slot 52 and collected to the collector H without being ejected to the field F when the exit of the medal M is changed to the second ejection slot 52 by the selector 34. The direction of dropping is not limited to one direction, and it may be a vertical direction, for example. The medal M moves along the rail 33 from the selector 34 to the first ejection slot 32 without dropping from the second ejection slot 52, and is ejected from the first ejection slot 32 to the field F, when the exit of the medal M is changed to the first ejection slot 32. In this variation, a shield may be arranged in the medal slot mechanism 30 so that the medal M ejected from the second ejection slot 52 to the collector H is hidden from the player. For example, a shield, which is a hollow component connecting with the second ejection slot 52 and the collector H so that the inside of that cannot be confirmed by sight, may be arranged in the medal slot mechanism 30. The medal M dropped from the second ejection slot 52 is ejected to collector H through the inside of the shield.

### B.5. Variation 5

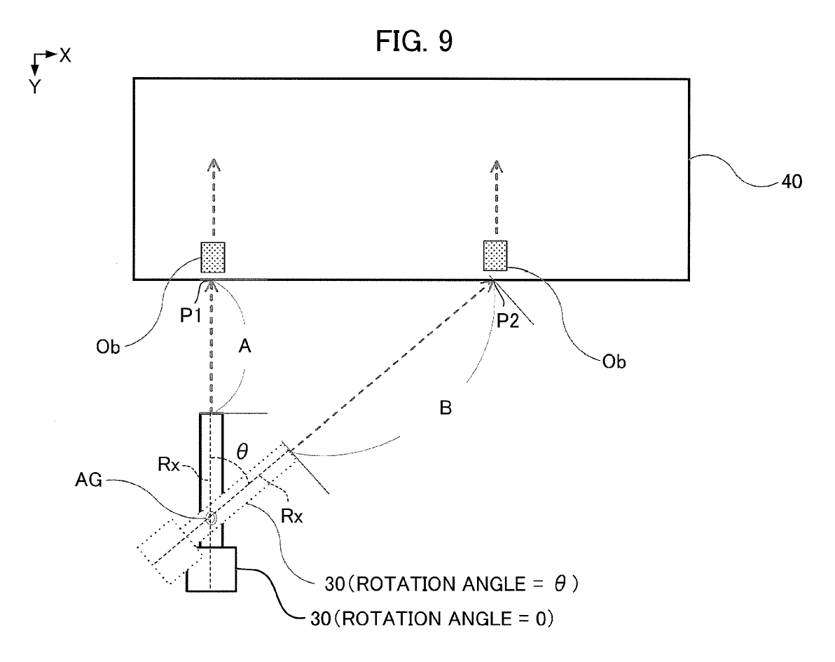

As is understood from FIG. 6, in the above-described embodiment, the direction of the movement of the image object M is controlled so that the direction of length of the rail 33 coincides with the direction of the movement of the image object Ob. However, the present invention is not limited to this example. The direction of length of the rail 33 may not coincide with the direction of the movement of the image objection Ob. For example, as shown in FIG. 9, the control device 10 may variably control the start position and the start timing for the display of the image object Ob in the display 40 corresponding to the rotation angle of the medal slot mechanism 30 and the timing when the medal M passes through the detector 35 in order to avoid awkwardness in display of the image object Ob (so far, this example is the same as the above-described embodiments). Furthermore, the direction of the movement of the image object Ob may be fixed to a constant direction (e.g., a vertical direction to the screen of the display 40 as shown in FIG. 9) independently of the rotation angle of the medal slot mechanism 30.

### B.6. Variation 6

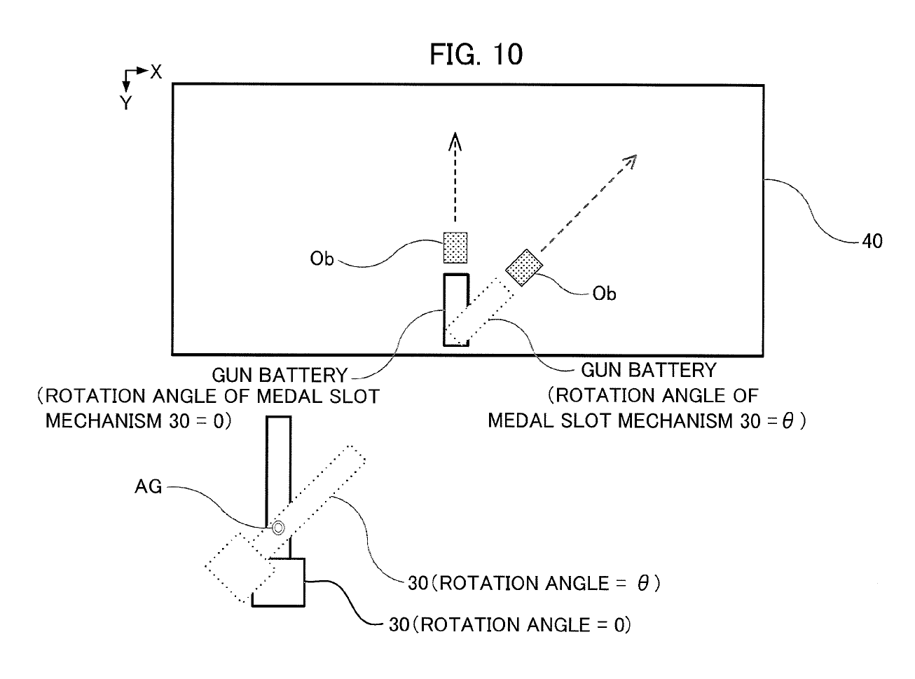

As shown in FIG. 10, when the shooting game is played, a gun battery may be displayed at a predetermined position in the screen of the display 40 (e.g., a position close to the center of the screen, etc.), and the image object Ob may be displayed so that it is shot from the tip of the gun battery. The gun battery is displayed so that it turns by following the rotation of the medal slot mechanism 30, and the direction of length of the gun battery coincides with that of the rail 33. In the example shown in FIG. 10, the direction of the movement of the image object Ob is controlled so that the direction of the movement of the image object Ob coincides with the direction of length of the rail 33. However, the present invention is not limited to this example. The direction of the movement of the image object Ob may be fixed independently of the rotation angle of the medal slot mechanism 30. In this example, which is different from the above-described embodiment, the timing when the display of the image object Ob starts may set variably corresponding to the timing when the medal M passes through the detector 35 independently of the rotation of the medal slot mechanism 30.

Without displaying the gun battery, the start position for displaying the image object Ob in the screen of the display 40 may be fixed in a predetermined position (e.g., a position close to the center of the screen of the display 40) independently of the rotation of the medal slot mechanism 30. Furthermore, the timing when the display of the image object Ob in the predetermined position starts may be set variably corresponding to the timing when the medal M passes through the detector 35 independently of the rotation of the medal slot mechanism 30. In this example, the control device 10 may control the direction of the movement of the image object Ob so that the direction of the movement of the image object Ob coincides with the direction of length of the rail 33.

### B.7. Variation 7

In the above-described embodiment, the medal M dropped from the effective edge EA is directly paid off to the player in the coin pusher game. However, the present invention is not limited to this example. For example, tickets corresponding to the number of medals M dropped from the effective edge EA may be given to the player. In short, if the medal M is dropped from the effective edge EA in the coin pusher game, the value corresponding to the number of the dropped medals M may be given to the player as a prize. Then, nothing may be given to the player as a prize if the medal is dropped from ineffective edge EB.

### B.8. Variation 8

The form or size of the image object Ob may be set freely. For example, an image such as that of a bullet, medal, etc., may be utilized as the image object Ob.

### DESCRIPTION OF REFERENCE NUMERALS

10: Control Device
20: Station
22: Coin Pusher Table
30: Medal Slot Mechanism
31: Insertion Slot
32: First Ejection Slot
33: Rail
34: Selector
35: Detector
36: Light Emitting Device
40: Display
50: Second Rail
52: Second Ejection Slot
60: Light Emitting Device
70: Rotation Detecting Device
80: Unusual Medal Ejecting Mechanism
82: Unusual Medal Storage
100: Game Apparatus
AG: Rotation Axis
d: Detection Signal
EA: Effective Edge
EB: Ineffective Edge
F: Field
H: Collector
M: Medal
Ob: Image Object

1. A game apparatus comprising:
a medal slot mechanism comprising:
a) an insertion slot into which a medal is inserted;
b) a first ejection slot adapted for ejecting the medal inserted from the insertion slot onto a field;
c) a rail capable of guiding the medal from the insertion slot to the first ejection slot;
d) a second ejection slot adapted for ejecting the medal inserted from the insertion slot into a collector different from the field;
e) a selector arranged in the rail and adapted for selecting one of either the first ejection slot or the second ejection slot as an exit of the medal; and
f) a detector arranged in a predetermined position in the rail between the insertion slot and the selector and adapted for detecting the medal passing through the predetermined position,
a control device adapted for controlling progress of a coin pusher game in that a pusher table moves with a reciprocating movement so that the medal ejected from the first ejection slot onto the field is pushed to move by the pusher table; and
a display adapted for displaying an image of games,
wherein the second ejection slot is arranged in one of either a leading edge of the second rail extended from the selector toward the collector or a second predetermined position in the rail between the detector and the first ejection slot;
the ejected medal inserted from the insertion slot is ejected onto the field without being ejected to the collector if the exit of the medal is changed to the first ejection slot by the selector, and the medal is ejected to the collector without being ejected to the field if the exit of the medal is changed to the second ejection slot by the selector,
if a first condition is satisfied, the control device controls the selector so that the exit of the medal is changed to the second ejection slot, and controls the display so that an image object is displayed in accordance with a timing when the medal passes through the detector.

2. The game apparatus according to claim 1, wherein, if a second condition is satisfied, the control device controls the display so that the exit of the medal is changed to the first ejection slot, and controls the display so that the image object is displayed in accordance with a timing when the medal passed through the detector.

3. The game apparatus according to claim 1, wherein the medal slot mechanism further comprises a rotation detecting device capable of rotating on an rotation axis and adapted for detecting a rotation angle of the rotation detecting device, and
the control device controls the display so that the image object is displayed in accordance with a timing when the rotation angle detected by the rotation detecting device and a timing when the medal passes through the detector.

4. The game apparatus according to claim 3, wherein the control device controls a direction of a movement of the image object on the basis of the rotation angle detected by the rotation detecting device.

5. The game apparatus according to claim 1, wherein the medal slot mechanism further comprises a rotation detecting device capable of rotating on a rotation axis and adapted for detecting a rotation angle of a rotation angle detected by the rotation detecting device, and
the control device controls a direction of a movement of the image object on the basis of the rotation angle detected by the rotation detecting device.

6. The game apparatus according to claim 1, wherein the control device controls a moving velocity of the image object in accordance with a time when the medal passes through.

7. The game apparatus according to claim 1, wherein an edge of the field in that the medal is capable of dropping is divided into effective edges and ineffective edges,
wherein if the medal is dropped from one of the effective edges, a value corresponding to the dropped medal is given to a player as a prize, and if the medal is dropped from one of the ineffective edges, the medal is collected to the collector without anything being given to the player as a prize.

8. The game apparatus according to claim 1, further comprising a shield for hiding the medal ejected from the second ejection slot to the collector from a player.

9. The game apparatus according to claim 1, wherein the medal slot mechanism comprises multiple light emitting devices arranged along the rail from the detector to the first ejection slot, and
the control device controls an emission of each of the light emitting devices on the basis of a timing when the medal passes through the detector.
